(19) United States
(12) Patent Application Publication
(10) Pub. No.: US 2020/0388405 A1
(43) Pub. Date: Dec. 10, 2020

(54) INFORMATION PROVISION DEVICE

(71) Applicant: LIXIL Corporation, Tokyo (JP)

(72) Inventors: Susumu ISHIDA, Tokyo (JP); Tomoko KASUYA, Tokyo (JP); Mikihiro OIDA, Tokyo (JP); Manabu NAMIKI, Tokyo (JP); Shinji SAKA, Tokyo (JP); Yuko YAMAJI, Tokyo (JP); Kazuki TERABE, Tokyo (JP)

(73) Assignee: LIXIL Corporation, Tokyo (JP)

(21) Appl. No.: 16/894,743

(22) Filed: Jun. 5, 2020

(30) Foreign Application Priority Data
Jun. 6, 2019 (JP) 2019-105809

(51) Int. Cl. G16Y 40/10; G16Y 40/35; G16Y 20/20; G16Y 20/10; G16Y 10/80

(52) U.S. Cl. CPC G16Y 40/10; G16Y 40/35; G16Y 10/80; G16Y 20/10; G16Y 20/20

(57) ABSTRACT

An information provision device includes: a detection information acquirer that acquires detection information regarding an object present in a living space including a building or premises where a person lives, lodges, or stays; a detection information retaining unit that stores detection information acquired by the detection information acquirer; and a provision information generator that generates provision information based on detection information stored in the detection information retaining unit. The detection information acquirer acquires detection information regarding a position of an object present in the living space. The provision information generator generates provision information based on whether or not there is a time variation in the position of an object present in the living space or based on the extent of the time variation.

### CROSS-REFERENCE TO RELATED APPLICATIONS

This application claims the priority of Japanese Application No. 2019-105809, filed Jun. 6, 2019, the entire contents of which are incorporated herein by reference.

### FIELD OF THE DISCLOSURE

The present disclosure relates to an information provision technology, and more particularly, to an information provision device that provides information regarding a living space.

### BACKGROUND OF THE DISCLOSURE

Houses are important bases for people's lives. To secure safe and comfortable lives, various technologies for improving housing security are provided (see Patent Document 1, for example).

Patent Document 1 (Japanese Unexamined Patent Application Publication No. 2002-329277) discloses a room entrance/exit monitoring system that uses a mobile information terminal carried by a user and that detects a human being, an animal, or an artifact passing through a room or a building while carrying a mobile information terminal, and transmits the result to the mobile information terminal of the user.

For conventional houses, security technologies for isolating the lives within the houses from outside society have been considered important to protect safety and privacy of the residents. However, for future houses, a function to coordinate the lives within the houses and outside society will be required to realize enriched lives with improved convenience. For example, situations can be considered in which, in a living space, a person other than the residents provides a service, such as housekeeping, caregiving, and delivery, to a resident, or enjoys a service, such as private lodging and parking space rental, from a resident.

In order to realize such new styles of houses and improve the convenience of residents, a technology for appropriately managing information regarding living spaces is required.

### SUMMARY OF THE DISCLOSURE

The present disclosure has been made in view of such a problem, and a purpose thereof is to provide a technology for improving the convenience of a resident in a living space.

To solve the problem above, an information provision device according to one aspect of the present disclosure includes; an acquirer that acquires detection information regarding an object present in a living space including a building or premises where a person lives, lodges, or stays; a storage unit that stores detection information acquired by the acquirer; and a generator that generates provision information based on detection information stored in the storage unit. The acquirer acquires detection information regarding a position of an object present in the living space. The generator generates the provision information based on whether or not there is a time variation in the position of an object present in the living space or based on the extent of the time variation.

Optional combinations of the aforementioned constituting elements, and implementation of the present disclosure in the form of methods, apparatuses, systems, recording media, and computer programs may also be practiced as additional modes of the present disclosure.

### BRIEF DESCRIPTION OF THE FIGURES

Some embodiments will now be described, by way of example only, with reference to the accompanying drawings which are meant to be exemplary, not limiting, and wherein like elements are numbered alike in several Figures, in which:

FIG. 1 is a diagram that shows a configuration of an information management system, according to some embodiments;

FIG. 2 is a diagram that shows a configuration of an information provision device, according to some embodiments; and

FIG. 3 is a diagram that shows an example of internal data of a condition retaining unit, according to some embodiments.

### DETAILED DESCRIPTION OF THE DISCLOSURE

The disclosure will now be described by reference to the some embodiments. This does not intend to limit the scope of the present disclosure, but to exemplify the disclosure.

To realize new styles of houses as described above, an information provision device according to some embodiments provides information regarding an object present within a house to a service provider who provides a service to a resident, or to a service receiver who enjoys a service from a resident. The information provision device of some embodiments provides, besides static information regarding an object present within a house, provision information generated based on whether or not there is a time variation in detection information, which is automatically and continuously detected by a sensor installed on a building component, furniture, a device, equipment, or the like within the house, or based on the extent of the time variation.

Since appropriate protection of privacy in a living space is also important, there is no need to provide all the detection information to every service provider or service receiver. In some embodiments, based on the details of the service provided by a service provider to a resident or the details of the service provided by a resident to a service receiver, only necessary information is precisely selected and provided. Accordingly, a resident can safely provide information regarding an object present within the house to a service provider and a service receiver and allow them to use the information, so that the resident's convenience can be improved, and an enriched life can be realized.

Such an information provision technology can be applied to arbitrary living spaces besides houses, including buildings or premises where persons live, lodge, or stay, such as accommodation facilities, premises including parking spaces or yards provided together with houses or accommodation facilities, and facilities where babies and infants or elderly persons can stay. The present disclosure, in some embodiments, may describe a technology for managing information regarding objects within a house.

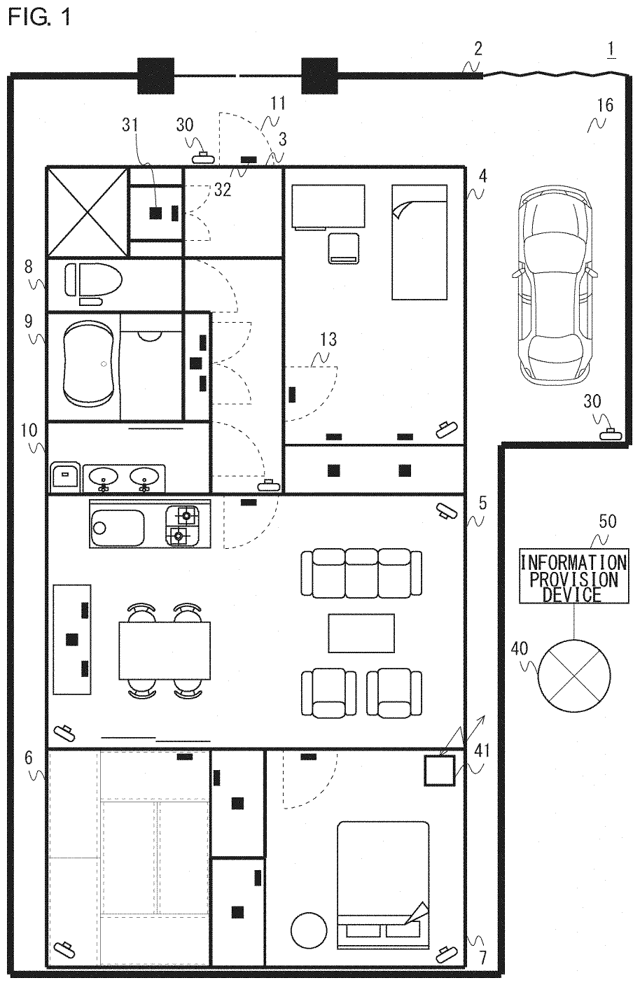

FIG. 1 shows a configuration of an information management system according to some embodiments. The information management system 1 includes a house 2, which is an example of a living space to be managed, and an information provision device 50 that generates and provides provision information based on detection information regarding an object present in the house 2. The house 2 includes multiple indoor areas including an entrance 3, a Western-style room 4, a living room (LDK) 5, a Japanese-style room 6, a bed room 7, a toilet 8, a bathroom 9, and a washroom 10, and multiple outdoor areas including a parking space 16.

In the house 2, an imaging device 30, a weight sensor 31, an RFID reader 32, and the like are installed as examples of sensors for detecting detection information including the position and state of an object present within the house 2. Such sensors are installed on building components, furniture, devices, or equipment installed in the house 2. The imaging device 30 captures an image of an area within the house 2. The information provision device 50 analyzes the image captured by the imaging device 30 to detect the position, kind, state, and the like of an object captured in the image. The weight sensor 31 is installed on the lower surface of a storage rack or on the floor to detect the weight of an object placed thereon. The RFID reader 32 is installed on a door 11 at the entrance 3, a room door, a door or a frame of a storage rack, or the like to read the ID of an object brought in or taken out through the door or frame. As a detection device, other arbitrary type of detection device may be installed in the house 2. For example, via communication with a communication device mounted on a device or equipment present within the house 2, information indicating the position or state of the device or equipment may be obtained. In this case, the device or equipment itself functions as a sensor. The information detected by such sensors is transmitted to a home server 41 via wireless communication. The home server 41 transmits the gathered information to the information provision device 50 via the Internet 40.

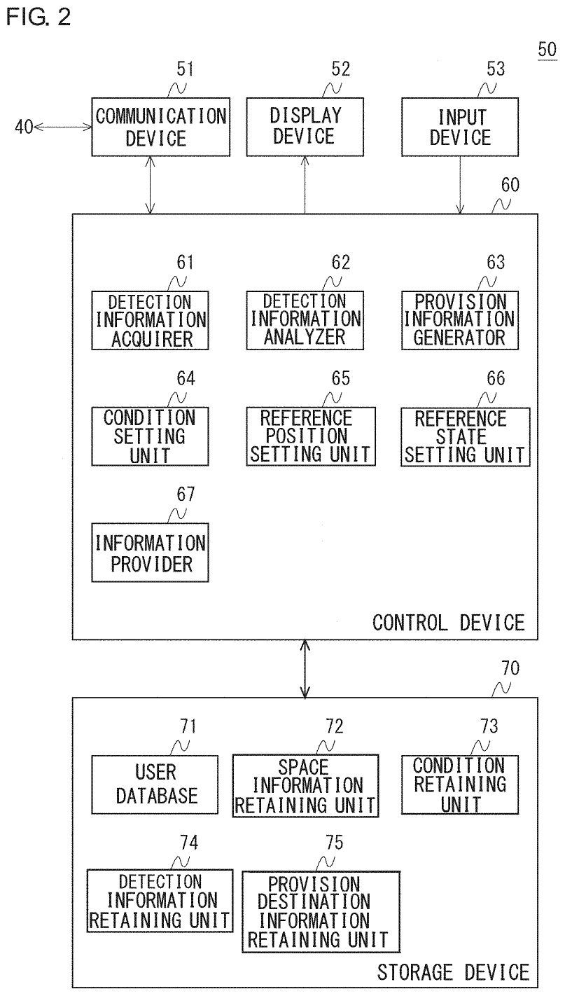

FIG. 2 shows a configuration of the information provision device according to some embodiments. The information provision device 50 includes a communication device 51, a display device 52, an input device 53, a control device 60, and a storage device 70. The information provision device 50 may be a server device, a personal computer, or other device, or may be a mobile terminal, such as a cellular phone terminal, a smartphone, and a tablet terminal.

The communication device 51 controls communication with other devices via a communication network, such as the Internet 40. The communication device 51 may perform communication using an arbitrary wired or wireless communication scheme. The display device 52 displays a screen generated by the control device 60. The display device 52 may be a liquid crystal display device, an organic EL display device, or the like. The input device 53 transmits, to the control device 60, an instruction input from a user or a manager of the information provision device 50. The input device 53 may be a mouse, a keyboard, a touch pad, or the like. The display device 52 and the input device 53 may be implemented as a touch panel.

The storage device 70 stores programs, data, and the like used by the control device 60. The storage device 70 may be semiconductor memory, a hard disk, or the like. The storage device 70 includes a user database 71, a space information retaining unit 72, a condition retaining unit 73, a detection information retaining unit 74, and a provision destination information retaining unit 75.

The user database 71 stores information on a user, such as a resident, who uses the information provision device 50. The space information retaining unit 72 stores information regarding a user's house. For example, the space information retaining unit 72 stores data indicating the shapes of multiple divided areas in the house 2, such as the floor plan of the house 2, information on the positions and shapes of building components, furniture, devices, equipment, storages, and the like installed in the house 2, and information on the types and positions of sensors including the imaging device 30, the weight sensor 31, and the RFID reader 32.

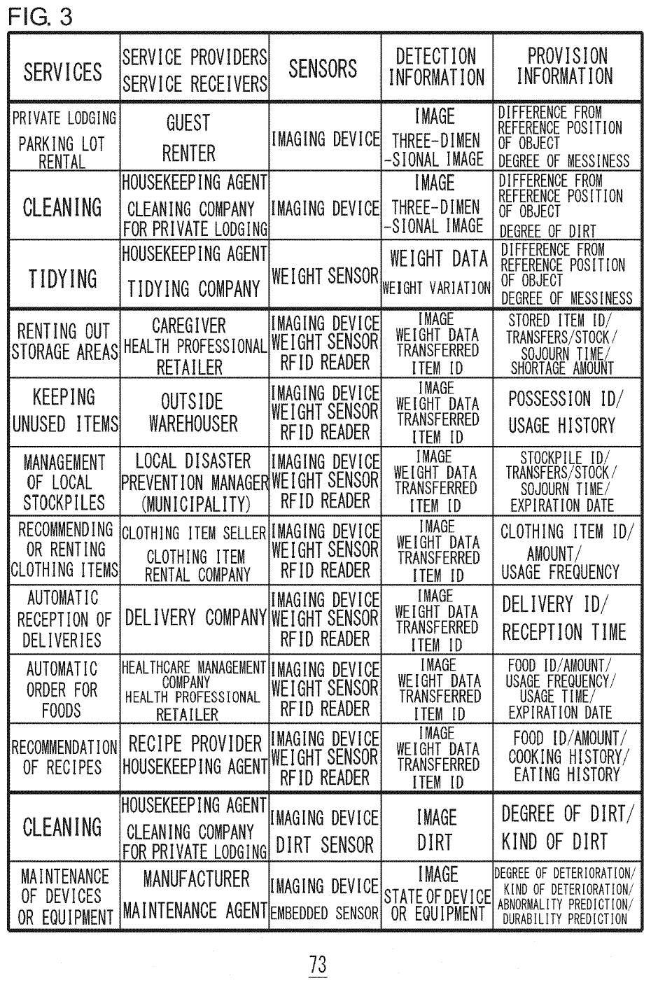

The condition retaining unit 73 stores a condition regarding provision information generated based on detection information detected by a sensor. FIG. 3 shows an example of internal data of the condition retaining unit 73. The condition retaining unit 73 retains provision information, and detection information used to generate the provision information, with respect to each service. Specific examples will be described later.

The detection information retaining unit 74 stores detection information acquired by a detection information acquirer 61. The provision destination information retaining unit 75 retains information regarding a service provider or a service receiver to whom provision information is provided.

The control device 60 includes the detection information acquirer 61, a detection information analyzer 62, a provision information generator 63, a condition setting unit 64, a reference position setting unit 65, a reference state setting unit 66, and an information provider 67. Each of these configurations may be implemented by a CPU or memory of any given computer, an LSI, or the like in terms of hardware, and by a memory-loaded program or the like in terms of software. In some embodiments are shown functional block configurations realized by cooperation thereof. Therefore, it would be understood by those skilled in the art that these functional blocks may be implemented in a variety of forms by hardware only or a combination of hardware and software.

The detection information acquirer 61 acquires detection information detected by a detection device installed within the house 2 and records the detection information in the detection information retaining unit 74. The detection information acquirer 61 may acquire the detection information from the home server 41, or directly from each detection device installed in the house 2.

The detection information analyzer 62 analyzes the detection information acquired by the detection information acquirer 61 and records the analysis result in the detection information retaining unit 74. The detection information analyzer 62 analyzes an image captured by the imaging device to acquire the kind, position, state, and the like of an object captured in the image. The detection information analyzer 62 may extract an object captured in the image by means of a technique of contour detection or pattern matching and acquire the kind, position, state, and the like of the extracted object. Also, the detection information analyzer 62 acquires the kind, amount, and the like of an object placed on the weight sensor 31, based on the weight detected by the weight sensor 31. Also, the detection information analyzer 62 acquires the kind, amount, and the like of an object brought in or taken out, based on the RFID detected by the RFID reader 32.

The provision information generator 63 refers to a condition retained in the condition retaining unit 73 to generate the provision information based on the detection information and the analysis result retained in the detection information retaining unit 74.

The condition setting unit 64 accepts, from a user, information regarding a provision destination to which the provision information is to be provided and the details of the provision information to be provided to the provision destination, and records the information thus accepted in the condition retaining unit 73 and the provision destination information retaining unit 75.

When the provision information generator 63 generates the provision information based on a difference between the position of an object present in a living space and a reference position of the object in the living space, the reference position setting unit 65 sets the reference position of the object in advance. The reference position may be specified by a user, or may be determined based on whether or not there is a time variation in the position of the object present in the living space or based on the extent of the time variation. In the latter case, the reference position setting unit 65 sets the reference position of the object based on a predetermined condition. For example, the position of the object at a predetermined point of time may be set as the reference position. Alternatively, the position at which the object has stayed longest during a predetermined period of time may be set as the reference position.

When the provision information generator 63 generates the provision information based on a difference between the state of an object present in a living space and a reference state of the object, the reference state setting unit 66 sets the reference state of the object in advance. The reference state may be specified by a user, or may be determined based on whether or not there is a time variation in the state of the object present in the living space or based on the extent of the time variation. In the latter case, the reference state setting unit 66 sets the reference state of the object based on a predetermined condition. For example, the state of the object at a predetermined point of time may be set as the reference state. Alternatively, the state in which the object has been kept longest during a predetermined period of time may be set as the reference state.

The information provider 67 refers to the provision destination information retaining unit 75 to provide the provision information generated by the provision information generator 63 to a predetermined provision destination. The information provider 67 may transmit or send the provision information to a device or an e-mail address of the provision destination. Also, the provision information may be displayed on the display device 52 or another display device installed within the house 2.

In the following, specific examples of services and provision information will be described with reference to FIG. 3. The specific examples fall roughly into three types: (1) examples of providing information regarding a time variation in the position of an object present in a living space; (2) examples of providing information regarding a time variation in the kind or amount of an object present in a living space; and (3) examples of providing information regarding a time variation in the state of an object present in a living space.

### 1. Time Variation in the Position of an Object

In an example of this category, the detection information acquirer 61 acquires the detection information regarding the position of an object present in a living space, and the provision information generator 63 generates the provision information based on whether or not there is a time variation in the position of the object present in the living space or based on the extent of the time variation.

### 1-1. Private Lodging

In this example, a resident provides a private lodging service for renting out part of or the entirety of a room to an outside service receiver, or a service for temporarily renting out the parking space 16 to an outside service receiver, for example. The detection information acquirer 61 acquires an image captured by an imaging device installed on a wall of a room or a parking lot, a ceiling, a crown molding, or in a hallway, which a service receiver can enter, or a three-dimensional image captured by an imaging device having a ranging function, for example. Based on an image or a three-dimensional image captured after the service receiver has used a room or the parking space 16, the provision information generator 63 provides, to the resident and the service receiver, the provision information indicating whether or not each object present in the living space is located at its reference position. Accordingly, information on an objective evaluation index indicating the degree of messiness in the living space after the service receiver has left, and information indicating whether pieces of equipment or devices placed in the living space have been returned to their original positions or whether such pieces of equipment or devices have not been taken out is provided, so that appropriate usage by the service receiver can be promoted.

### 1-2. Cleaning

In this example, a resident is provided with a service in which a housekeeping agent cleans up a living space, or a service in which a person from a cleaning company cleans up a room after a service receiver, who used the room for private lodging, has left, for example. The detection information acquirer 61 acquires an image captured by an imaging device installed on a wall of each room, a ceiling, a crown molding, or in a hallway, or a three-dimensional image captured by an imaging device having a ranging function, for example. Based on images captured by an imaging device before and after the cleaning, for example, the provision information generator 63 provides, to the resident and the service provider, the provision information indicating whether or not each object present in the living space is located at its reference position. Accordingly, information on objective evaluation indexes indicating the degrees of dirt in the living space before and after the cleaning, and information indicating whether pieces of equipment or devices placed in the living space have been returned to their original positions or whether such pieces of equipment or devices have not been taken out is provided, so that appropriate cleaning by the service provider can be promoted.

### 1-3. Tidying

In this example, a resident is provided with a service in which a housekeeping agent tidies up a living space, or a service in which a person from a tidying company tidies up a room after a service receiver, who used the room for private lodging, has left, for example. The detection information acquirer 61 acquires weight detected by a weight sensor installed on the floor of each room or a hallway, for example. Based on the weight before and after the tidying, for example, the provision information generator 63 provides, to the resident and the service provider, the provision information indicating whether or not each object present in the living space is located at its reference position. Accordingly, information on objective evaluation indexes indicating the degrees of messiness in the living space before and after the tidying, and information indicating whether objects placed in the living space have been returned to their original positions or whether such objects have not been taken out is provided, so that appropriate tidying by the service provider can be promoted.

### 2. Time Variation in the Kind or Amount of an Object

In an example of this category, the detection information acquirer 61 acquires the detection information regarding the kind or amount of an object present in a living space, and the provision information generator 63 generates the provision information based on whether or not there is a time variation in the kind or amount of the object present in the living space or based on the extent of the time variation. The provision information generator 63 generates the provision information based on whether or not there is a time variation in the kind or amount of an object mounted on or stored in a building component, furniture, or equipment installed in the living space, or based on the extent of the time variation, for example.

### 2-1. Renting Out Storage Areas

In this example, a resident is provided with a service in which an outside vendor stores medicines, nursing care products, foods, drinks, consumer products, or the like in a storage area, such as a storage box, installed in the entrance or other place within the house 2 to sell them or rent them out to the resident. The detection information acquirer 61 acquires an image captured by an imaging device installed in the storage area, weight detected by a weight sensor installed on a bottom surface in the storage area, and the ID of an item that has been transferred through a frame or a door in the storage area, detected by an RFID reader installed on the frame or door, for example. The provision information generator 63 provides, to the service provider, the provision information, including the ID, transfers, stock, sojourn time, and shortage amount of an item stored in the storage area. Accordingly, the service provider can precisely grasp the state of the storage area within the house 2 without visiting the house 2, so that the service provider can replenish the stocks in the storage area, propose stocking other items, or charge a fee for an item consumed or used by the resident. Multiple storage areas may be related respectively to multiple vendors. In this case, the provision information generator 63 generates the provision information for each of multiple information provision destinations, based on whether or not there is a time variation in the kind or amount of an object present in an area related to the information provision destination, or based on the extent of the time variation.

### 2-2. Keeping Unused Items

In this example, a resident is provided with a service in which an outside warehouser keeps an item currently not used by the resident. The detection information acquirer 61 acquires an image captured by an imaging device installed in a storage area within the house 2, weight detected by a weight sensor installed on a bottom surface in the storage area, and the ID of an item that has been transferred through a frame or a door in the storage area, detected by an RFID reader installed on the frame or door, for example. The provision information generator 63 provides, to the service provider, the provision information, including the ID, transfers, and usage history of an item stored in the storage area. Accordingly, the service provider can grasp the usage states of items stored in the storage area within the house 2, so that the service provider can propose keeping a less frequently used item to the resident.

### 2-3. Local Stockpiles

In this example, an administrative service is provided for overall management of emergency supplies, foods, and drinks stockpiled by residents living in the local area. The detection information acquirer 61 acquires an image captured by an imaging device installed in a storage area within the house 2, weight detected by a weight sensor installed on a bottom surface in the storage area, and the ID of an item that has been transferred through a frame or a door in the storage area, detected by an RFID reader installed on the frame or door, for example. The provision information generator 63 provides, to the service provider, the provision information, including the ID, transfers, stock, and sojourn time of an item stored in the storage area. Accordingly, a municipality managing the local disaster prevention can grasp the amounts, expiration dates, or the like of items stockpiled in the house 2 within the local area, so that the municipality can appropriately manage the stockpiles of emergency supplies, foods, and drinks in the local area. Also, the municipality can propose, to a resident, additional stockpiles or replacement of expired foods and drinks, as needed. Instead of the resident, the information provision device 50 may automatically order the emergency supplies, foods, or drinks.

### 2-4. Recommending or Renting Clothing Items

In this example, a resident is provided with a service for recommending or renting an item, such as a clothing item, used by the resident. The detection information acquirer 61 acquires an image captured by an imaging device installed in a storage area within the house 2, weight detected by a weight sensor installed on a bottom surface in the storage area, and the ID of an item that has been transferred through a frame or a door in the storage area, detected by an RFID reader installed on the frame or door, for example. The provision information generator 63 provides, to the service provider, the provision information, including the ID, the amount, transfers, and usage history of an item, such as a clothing item, stored in the storage area. Accordingly, the service provider can precisely grasp the kinds or amounts of items owned by the resident, the state of usage of each item by the resident, and the resident's preference for items, so that the service provider can appropriately select a candidate of items to be sold or rented to the resident and recommend the candidate to the resident. When an item is rented to the resident, a rent can be charged based on the state of usage of the item by the resident.

### 2-5. Automatic Reception of Deliveries

In this example, a resident is provided with a service for automatically receiving a delivery delivered to the resident. The detection information acquirer 61 acquires an image captured by an imaging device installed in the entrance or other place in the house 2, weight detected by a weight sensor installed on a bottom surface of a storage box installed in the entrance or other place in the house 2, and the ID of a delivery detected by an RFID reader installed on a frame or a door of the storage box, for example. The provision information generator 63 provides, to the resident and the service provider, the provision information, including the ID and the reception time of a delivery. Accordingly, the resident can receive deliveries even when the resident is not at home.

### 2-6. Automatic Order for Foods

In this example, a resident is provided with a service for managing the stocks of foods or seasonings kept in a refrigerator or a storage area for foods provided in a kitchen or other place within the house 2. The detection information acquirer 61 acquires an image captured by an imaging device installed in a kitchen within the house 2, weight detected by a weight sensor installed on a bottom surface of a refrigerator or in a storage area, and the ID of an item that has been transferred through a frame or a door of the refrigerator or in the storage area, detected by an RFID reader installed on the frame or door, for example. The provision information generator 63 provides, to the service provider, the provision information, including the ID, amount, transfers, usage frequency, usage time, and expiration date of a food or seasoning stored in the refrigerator or storage area. Accordingly, the service provider can precisely grasp the kinds, amounts, or used amounts of foods or seasonings that the resident has, so that necessary foods or seasonings can be automatically ordered, and the stocks can be replenished.

### 2-7. Recommendation of Recipes

In this example, a resident is provided with a service for recommending a candidate of food to be cooked or eaten by the resident. The detection information acquirer 61 acquires an image captured by an imaging device installed in a kitchen or a dining room within the house 2, weight detected by a weight sensor installed on a bottom surface of a refrigerator or in a storage area for storing foods or seasonings within the house 2, and the ID of an item that has been transferred through a frame or a door of the refrigerator or in the storage area, detected by an RFID reader installed on the frame or door, for example. The provision information generator 63 provides, to the service provider, the provision information, including the ID, the amount, transfers, and sojourn time of a food or seasoning stored in the refrigerator or storage area, and the kind or amount of food cooked or eaten by the resident. Accordingly, the service provider can precisely grasp the kinds or amounts of foods or seasonings that the resident has, the history of food cooked or eaten by the resident, and the resident's preference for food, so that the service provider can appropriately select a candidate of food to be cooked or eaten by the resident and recommend the candidate to the resident.

### 3. Time Variation in the State of an Object

In an example of this category, the detection information acquirer 61 acquires the detection information regarding the kind or amount of an object present in a living space, and the provision information generator 63 generates the provision information further based on whether or not there is a time variation in the kind or amount of the object present in the living space or based on the extent of the time variation.

### 3-1. Cleaning

In this example, a resident is provided with a service in which a housekeeping agent cleans up a living space, or a service in which a person from a cleaning company cleans up a room after a service receiver, who used the room for private lodging, has left. The detection information acquirer 61 acquires an image captured by an imaging device installed on a wall of a room, a ceiling, a floor, furniture, a window, or in a kitchen or a toilet, and information indicating the degree of dirt detected by a dirt sensor, for example. The provision information generator 63 provides, to the resident and the service provider, the provision information indicating the kind and degree of the dirt. Accordingly, information on objective evaluation indexes indicating the degrees of dirt in the living space before and after the cleaning is provided, so that appropriate cleaning by the service provider can be promoted.

### 3-2. Maintenance of Devices or Equipment

In this example, a resident is provided with a service in which the manufacturer or a maintenance agent of furniture, a device, or equipment within the house 2 performs maintenance on the furniture, device, or equipment. The detection information acquirer 61 acquires information indicating the state of furniture, a device, or equipment, from a sensor installed or mounted on the furniture, device, or equipment, for example. The provision information generator 63 provides, to the resident and the service provider, the provision information, including the degree or kind of deterioration, the history or prediction of abnormal states, and prediction of durability, with regard to furniture, a device, or equipment. Accordingly, information on objective evaluation indexes indicating the state of the furniture, the device, or the equipment within the house 2 is provided, so that appropriate maintenance by the service provider can be promoted.

As described in the examples above, with the technology of the present disclosure, the detection information automatically detected by a sensor installed on a building component, furniture, a device, equipment, or the like within a house is continuously gathered, and the provision information appropriate for each information provision destination is generated and provided based on whether or not there is a time variation in the position, state, kind, or amount of an object present within the house or based on the extent of the time variation. This can support the resident and an outside service provider or service receiver who build enriched lives in cooperation with each other.

Although the present disclosure describes examples in which the information provision device 50 is provided for overall management of multiple houses, the information provision device 50 may be provided for each house. In this case, the home server 41 may have the functions of the information provision device 50, for example. Also, the functions may be allocated to the home server 41 and the information provision device 50. For example, the home server 41 may manage information that should not be disclosed, such as personal information of a resident or manager of the house 2, and the information provision device 50 may manage information input from or output to a service provider or a service receiver. This can also improve the security of information. In another example, the home server 41 need not be provided. In this case, sensors, devices, and equipment communicate directly with the information provision device 50.

When the disclosure embodied by the embodiments and modifications set forth above are generalized, the following technical ideas may be derived.

An information provision device according to one aspect of the present disclosure includes; an acquirer that acquires detection information regarding an object present in a living space including a building or premises where a person lives, lodges, or stays; a storage unit that stores detection information acquired by the acquirer; and a generator that generates provision information based on detection information stored in the storage unit. The acquirer acquires detection information regarding a position of an object present in the living space. The generator generates the provision information based on whether or not there is a time variation in the position of an object present in the living space or based on the extent of the time variation. According to this aspect, information regarding a time variation in the position of an object present in a living space is provided to a service provider or a service receiver, so that the service quality can be improved, and the resident's convenience can also be improved.

The generator may generate the provision information based on a difference between the position of an object present in the living space and a reference position of the object in the living space. According to this aspect, the resident's convenience can be improved.

The reference position may be specified by a user, or may be determined based on whether or not there is a time variation in the position of the object present in the living space or based on the extent of the time variation. According to this aspect, the resident's convenience can be improved.

The acquirer may further acquire detection information regarding a kind or an amount of an object present in the living space, and the generator may generate the provision information further based on whether or not there is a time variation in the kind or amount of an object present in the living space or based on the extent of the time variation. According to this aspect, information regarding a time variation in the kind or amount of an object present in a living space is provided to a service provider or a service receiver, so that the service quality can be improved, and the resident's convenience can also be improved.

The generator may generate the provision information based on whether or not there is a time variation in the kind or amount of an object present in a specific area within the living space or based on the extent of the time variation. According to this aspect, the resident's convenience can be improved while the resident's privacy is appropriately protected.

The generator may generate the provision information for each of multiple information provision destinations, based on whether or not there is a time variation in the kind or amount of an object present in an area related to the information provision destination, or based on the extent of the time variation. According to this aspect, the resident's convenience can be improved.

The generator may generate the provision information based on whether or not there is a time variation in the kind or amount of an object mounted on or stored in a building component, furniture, or equipment installed in the living space, or based on the extent of the time variation. According to this aspect, the resident's convenience can be improved.

The acquirer may further acquire detection information regarding a state of an object present in the living space, and the generator may generate the provision information further based on whether or not there is a time variation in the state of an object present in the living space or based on the extent of the time variation. According to this aspect, information regarding a time variation in the state of an object present in a living space is provided to a service provider or a service receiver, so that the service quality can be improved, and the resident's convenience can also be improved.

The generator may generate the provision information based on a difference between the state of an object present in the living space and a reference state of the object. According to this aspect, the resident's convenience can be improved.

The reference state may be specified by a user, or may be determined based on whether or not there is a time variation in the state of the object present in the living space or based on the extent of the time variation. According to this aspect, the resident's convenience can be improved.

An information provision method according to another aspect of the present disclosure includes: acquiring detection information regarding a position of an object present in a living space including a building or premises where a person lives, lodges, or stays, and storing the detection information in a storage unit; and generating provision information based on whether or not there is a time variation in detection information regarding a position of an object present in the living space stored in the storage unit or based on the extent of the time variation. According to this aspect, information regarding a time variation in the position of an object present in a living space is provided to a service provider or a service receiver, so that the service quality can be improved, and the resident's convenience can also be improved.

What is claimed is:

1. An information provision device, comprising:
an acquirer that acquires detection information regarding an object present in a living space including a building or premises where a person lives, lodges, or stays;
a storage unit that stores detection information acquired by the acquirer; and
a generator that generates provision information based on detection information stored in the storage unit, wherein
the acquirer acquires detection information regarding a position of an object present in the living space, and
the generator generates the provision information based on whether or not there is a time variation in the position of an object present in the living space or based on the extent of the time variation.

2. The information provision device of claim 1, wherein the generator generates the provision information based on a difference between the position of an object present in the living space and a reference position of the object in the living space.

3. The information provision device of claim 2, wherein the reference position is specified by a user, or is determined based on whether or not there is a time variation in the position of the object present in the living space or based on the extent of the time variation.

4. The information provision device of claim 1, wherein
the acquirer further acquires detection information regarding a kind or an amount of an object present in the living space, and
the generator generates the provision information further based on whether or not there is a time variation in the kind or amount of an object present in the living space or based on the extent of the time variation.

5. The information provision device of claim 4, wherein the generator generates the provision information based on whether or not there is a time variation in the kind or amount of an object present in a specific area within the living space or based on the extent of the time variation.

6. The information provision device of claim 5, wherein the generator generates the provision information for each of a plurality of information provision destinations, based on whether or not there is a time variation in the kind or amount of an object present in an area related to the information provision destination, or based on the extent of the time variation.

7. The information provision device of claim 5, wherein the generator generates the provision information based on whether or not there is a time variation in the kind or amount of an object mounted on or stored in a building component, furniture, or equipment installed in the living space, or based on the extent of the time variation.

8. The information provision device of claim 1, wherein
the acquirer further acquires detection information regarding a state of an object present in the living space, and
the generator generates the provision information further based on whether or not there is a time variation in the state of an object present in the living space or based on the extent of the time variation.

9. The information provision device of claim 8, wherein the generator generates the provision information based on a difference between the state of an object present in the living space and a reference state of the object.

10. The information provision device of claim 9, wherein the reference state is specified by a user, or is determined based on whether or not there is a time variation in the state of the object present in the living space or based on the extent of the time variation.

11. An information provision method, comprising:
acquiring detection information regarding a position of an object present in a living space including a building or premises where a person lives, lodges, or stays, and storing the detection information in a storage unit; and
generating provision information based on whether or not there is a time variation in detection information regarding a position of an object present in the living space stored in the storage unit or based on the extent of the time variation.

12. The information provision device of claim 2, wherein
the acquirer further acquires detection information regarding a kind or an amount of an object present in the living space, and
the generator generates the provision information further based on whether or not there is a time variation in the kind or amount of an object present in the living space or based on the extent of the time variation.

13. The information provision device of claim 3, wherein
the acquirer further acquires detection information regarding a kind or an amount of an object present in the living space, and
the generator generates the provision information further based on whether or not there is a time variation in the kind or amount of an object present in the living space or based on the extent of the time variation.

14. The information provision device of claim 6, wherein the generator generates the provision information based on whether or not there is a time variation in the kind or amount of an object mounted on or stored in a building component, furniture, or equipment installed in the living space, or based on the extent of the time variation.

15. The information provision device of claim 2, wherein
the acquirer further acquires detection information regarding a state of an object present in the living space, and
the generator generates the provision information further based on whether or not there is a time variation in the state of an object present in the living space or based on the extent of the time variation.

16. The information provision device of claim 3, wherein
the acquirer further acquires detection information regarding a state of an object present in the living space, and
the generator generates the provision information further based on whether or not there is a time variation in the state of an object present in the living space or based on the extent of the time variation.

17. The information provision device of claim 4, wherein
the acquirer further acquires detection information regarding a state of an object present in the living space, and
the generator generates the provision information further based on whether or not there is a time variation in the state of an object present in the living space or based on the extent of the time variation.

18. The information provision device of claim 5, wherein
the acquirer further acquires detection information regarding a state of an object present in the living space, and
the generator generates the provision information further based on whether or not there is a time variation in the state of an object present in the living space or based on the extent of the time variation.

19. The information provision device of claim 6, wherein
the acquirer further acquires detection information regarding a state of an object present in the living space, and
the generator generates the provision information further based on whether or not there is a time variation in the state of an object present in the living space or based on the extent of the time variation.

20. The information provision device of claim 7, wherein
the acquirer further acquires detection information regarding a state of an object present in the living space, and
the generator generates the provision information further based on whether or not there is a time variation in the state of an object present in the living space or based on the extent of the time variation.
